(19) United States
(12) Patent Application Publication
(10) Pub. No.: US 2015/0120204 A1
(43) Pub. Date: Apr. 30, 2015

(54) TRANSCRIPTOME ASSEMBLY METHOD AND SYSTEM

(71) Applicants: Gengxiong Wu, Shenzhen (CN); Weihua Huang, Shenzhen (CN); Yinlong Xie, Shenzhen (CN); Jingbo Tang, Shenzhen (CN); Jun Wang, Shenzhen (CN); Jian Wang, Shenzhen (CN); Huanming Yang, Shenzhen (CN)

(72) Inventors: Gengxiong Wu, Shenzhen (CN); Weihua Huang, Shenzhen (CN); Yinlong Xie, Shenzhen (CN); Jingbo Tang, Shenzhen (CN); Jun Wang, Shenzhen (CN); Jian Wang, Shenzhen (CN); Huanming Yang, Shenzhen (CN)

(73) Assignee: BGI TECH SOLUTIONS CO., LTD., Shenzhen (CN)

(21) Appl. No.: 14/394,135

(22) PCT Filed: Apr. 13, 2012
(86) PCT No.: PCT/CN2012/074007

§ 371 Date: Oct. 13, 2014

(51) Int. Cl. G06F 19/22; G06F 19/20

(52) U.S. Cl. CPC G06F 19/22; G06F 19/20
USPC 702/19

(57) ABSTRACT

Provided is a transcriptome assembly method, comprising the following steps of: constructing a sequencing sample transcriptome read into a de Brujin graph; performing filtering and linearization processing on the de Brujin graph, so as to form continuous contigs; obtaining association among the contigs, and filtering association data; performing linearization processing on a continuous sequence without bifurcation; outputting a contig sequence; comparing the read and an end pairing read with the output contig sequence, so as to obtain information between the read and the contig; establishing connections among the contigs, so as to construct a graph with the contigs as points and the connections as edges; pre-processing and dividing the obtained graph, so as to obtain independent sub-graphs; and outputting a transcript according to the sub-graphs. Further provided is a transcriptome assembly system based on the method.

### TECHNICAL FIELD

Embodiments of the present disclosure generally relate to fields of biotechnology and bioinformatics, more particularly, to a method of assembling a transcriptome and a system thereof.

### BACKGROUND

In a broad sense, a transcriptome refers to a set of all intracellular transcription products in a certain physiological condition, including messenger RNA (mRNA), ribosomal RNA, transfer RNA, and non-coding RNA; in a narrow sense, a transcriptome refers to a set of all messenger RNA. Since a transcriptome represents a gene expression state of an organism in a certain moment, thus the study of a transcriptome has a great significant for biology.

After obtaining a sample, obtaining a nucleic acid and sequencing on computer, if transcriptome information of an organism needs to be obtained, an assembly of a transcriptome is still required. The assembly of the transcriptome not only should face problems such as sequencing error, duplicate sequence and heterozygous, but also should deal with phenomenon such as alternatively splicing and uneven depths, which lead to severe problems to denovo assembling algorithm, resulting in that an error correction model of an initial genome cannot effectively deal with sequencing error, as well as cannot shield a problem of duplicate sequence using a method combining depth with out- and in-degree, along with the most severe problem of being not able to assemble a transcriptome having alternative splicing. Current software for transcriptome assembly mainly includes Velvet-Oases and Trinity. Velvet-Oases incorporate Oases based on genome assembly software Velvet, by following a correction model of genome with a difference of using multi-corrections comparing to the original version, while using a method of weighted graph, which may perform transcriptome assembly with an overtop false positive result, having a large amount of high-similar sequences without enough integrity. Directing characteristics of transcriptome, Trinity software introduce a new error removal model and a rigorous composition manner, but with a time-consuming program, which cannot uses insert fragments having a larger length or multi-library data, with a low-continuous result.

So far, there is still no method (system/software) in the art, which may not only guarantee integrity and continuity of result, but also ensure controllable consuming time. Thus, it is urgent to develop a method for transcriptome assembly in the art, being accurate, convenient and economic.

### SUMMARY

One purpose of the present disclosure is to provide a method for transcriptome assembly and a system thereof.

Another purpose of the present disclosure is to provide a use of the method and system.

In a first aspect of the present disclosure, there is provided a method for contig assembly, comprising following steps:

(1) constructing a de Brujin graph based on transcriptomic reads obtained from a sample;

(2) subjecting the de Brujin graph obtained in the step (1) to a first filtration and a first linearization, to form continuous contigs;

(3) obtaining a connection relationship among the contigs, and subjecting the connection relationship to a second filtration;

(4) subjecting continuous contigs without a fork to a second linearization;

(5) repeating step the (3) and the step (4) until a sequence presents no changes, to obtain the sequence assembling with contigs.

In another preferred example, the transcriptomic reads in the step (1) is obtained by high-throughput sequencing, which comprises: subjecting a sequencing product to be tested to a hybridization with a sequencing probe fixed on a solid-phase carrier, and then to a solid-phase bridge PCR amplification, to form a sequencing cluster; and subjecting the sequencing cluster to sequencing by means of synthesis by sequencing, to obtain the transcriptomic reads from the sample.

In another preferred example, the first filtration in the step (2) is selected from following:

(a) deleting an unconfident tuple;

(b) deleting a tuple having a low depth;

(c) removing a tip having a length being less than twice of one tuple's length; or

(d) a combinations thereof.

In another preferred example, the unconfident tuple is that: in a tuple set having same out-degree or in-degree of one tuple, taking the maximum depth as a standard, a tuple having a depth being less than 10% (preferably 5%) of the standard is the unconfident tuple.

In another preferred example, the low depth is a depth being no more than 3, preferably a depth being no more than 2, more preferably a depth being 0.

In another preferred example, the depth being 0 indicates that a user does not use such function.

In another preferred example, the connection relationship between contigs in the step (3) is that: based on a sequence having a length of k+1 in a read, the connection relationship equals to frequencies of reads supporting a region having the length of k+1.

In another preferred example, the second filtration in the step (3) is selected from following:

(a1) deleting connection data having a low depth;

(b1) deleting unconfident connection data; or

(c1) a combinations thereof.

In another preferred example, the step of deleting unconfident connection data comprises:

(i) deleting connection data between a continuous sequences of which one sequence has a low weight and the other sequence connected thereof has a high depth;

(ii) deleting connection data among continuous sequences having a low weight, in the case of the continuous sequences having a plurality of out-degrees with a large difference therein;

(iii) deleting connection data among continuous sequences having a low weight, in the case of the continuous sequences having both the out-degree and the in-degree with a large difference therein; or

(iv) a combination thereof.

In another preferred example, the high depth in the (i) is that: the other sequence connected thereof has a depth being 25 times higher than the weight of the connection data between the continuous sequence, preferably, being 30 times higher than the weight of the connection data between the continuous sequence.

In another preferred example, the low weight in the (i) is that: the one sequence has a weight being less than 3 (preferably, being less than 2).

In another preferred example, in an out-degree set consisting of the plurality of out-degrees among the continuous sequences in the (ii), connection data having a weight being less than 3% of the maximum weight among the continuous sequences is the connection data having the low weight.

In another preferred example, the large differences among the plurality of out-degrees in the (ii) refers that the minimum out-degree is 5% or more smaller than the maximum out-degree, preferably 10% or more smaller than the maximum out-degree.

In another preferred example, in the case of having both the out-degree and the in-degree in the (iii), calculating a weight sum of the connection data among all continuous sequences within the out-degree, and deleting connection data having a weight being less than 2% of the weight sum within the out-degree; calculating a weight sum of the connection data among all continuous sequences within the in-degree, and deleting connection data having a weight being less than 2% of the weight sum within the in-degree.

In a second aspect of the present disclosure, there is provided a method for brackets assembly, comprising following steps:

(a) obtaining contig data for assembling, aligning a single-end read and a paired-end read to the contig data, to obtain information between reads and contigs;

(b) establishing a connection among the contigs, constructing a graph taking the contigs as dots and the connection as a side;

(c) subjecting the graph obtained in the step (b) to a pre-treatment and a division, to obtain a plurality of separate subgraphs;

(d) outputting a transcript based on the plurality of subgraphs obtained in the step (c).

In another preferred example, the information between reads and contigs in the step (a) is selected from following groups: an initial position, an aligning length, a direction, or a combination thereof.

In another preferred example, the connection among the contigs in the step (b) is selected from following groups: a read supporting number, a gap between contigs, or a combination thereof.

In another preferred example, the pre-treatment in the step (c) is selected from following groups:

(A) deleting a connection among contigs having a weight being less than 3;

(B) subjecting to a linearization, to deal with redundant information;

(C) subjecting to a decyclization; or

(D) a combination thereof.

In another preferred example, the step of subjecting to the decyclization refers to deleting duplicate sequence, and/or cycling information caused by error sequencing.

In another preferred example, the decyclization comprises: finding a cycle based on a graph theory of strong connected branches; and deleting a connection having a minimum weight within the cycle.

In another preferred example, the subgraph in the step (d) comprises: a line graph, a branch graph, a bubble graph, a complex graph, or a combination thereof.

In another preferred example, the line graph refers that: the out- and in-degrees of all continuous contigs are all less than 1.

In another preferred example, the branch graph refers that: a graph connected by contigs only has one fork.

In another preferred example, the bubble graph refers that: a graph connected by contigs only has one bubble.

In another preferred example, the complex graph refers that: a graph besides the line graph, the branch graph and the bubble graph.

In a third aspect of the present disclosure, there is provided a method for transcriptome assembly, comprising following steps:

(A) performing contig assembly using the method according to the first aspect of the present disclosure, to obtain contig data; and

(B) subjecting the contig data to a bracket assembly using the method according to the second aspect of the present disclosure, to obtain transcript data.

In a fourth aspect of the present disclosure, there is provided a unit for contig assembly, comprising:

(A1) a tuple constructing module, for constructing a de Brujin graph with sequenced transcriptomic reads;

(B1) a tuple filtering module, for subjecting a tuple to a first filtration;

(C1) a tuple linearizing module, for subjecting a tuple without a fork to a first linearization, to obtain continuous contigs;

(D1) a connection processing module, for obtaining a connection relationship among the contigs, and subjecting the connection relationship to a second filtration and a second linearization;

(E1) an outputting module, for outputting a sequence assembling with contigs.

In a fifth aspect of the present disclosure, there is provided a unit for bracket assembly, comprising:

(A2) an aligning module, for aligning a single-end read and a paired-end read to contigs, to obtain information between reads and the contigs;

(B2) a graph constructing module, for constructing a graph, and/or subjecting the graph to a pre-treatment;

(C2) a subgraph processing module, for dividing the graph into a plurality of separate subgraphs;

(D2) a subgraph assembling module, for subjecting transcripts obtained from the plurality of separate subgraphs to assembly, to obtain transcript assembling information.

In a sixth aspect of the present disclosure, there is provided a system for transcriptome assembly, comprising:

(A) the unit for contig assembly according to the fourth aspect of the present disclosure, for assembling reads having an overlap; and

(B) the unit for bracket assembly according to the fifth aspect of the present disclosure, for assembling the contigs into an integrated transcriptome.

It should be understood within the scope of the present disclosure, the above-mentioned technical features and technical features mentioned below (such as example) can be combined freely and mutually to form new or preferred technical solutions, which are omitted for brevity.

### BRIEF DESCRIPTION OF THE DRAWINGS

The following drawings illustrate specific embodiments of the present disclosure, without intending to limit scope of the present disclosure as defined by claims.

FIG. 1 is a flow chart showing a principle of transcriptome assembly in a preferred example of the present disclosure.

### DETAILED DESCRIPTION

Through extensive and deepen researches by inventors of the present disclosure, a method of transcriptome assembly and a system thereof are firstly established, being accurate, convenient and economy. In contig assembly, using a ratio method is that: in one transciptome, even if sequencing error has a certain depth, it is still relative lower comparing to that of the transcriptome; the error sequencing may be effectively removed according to a ratio cut-off set by the method of the present disclosure. In bracket assembly, a scaffold graph is divided into a plurality of subgraphs, in which one subgraph indicates one transcriptome, which may output integrate and continuous transcript.

In details, the method may comprise: constructing a de Brujin graph based on transcriptomic reads obtained from a sample; subjecting the de Brujin graph to a first filtration and a first linearization, to form continuous sequences, namely, contigs; obtaining a connection relationship among the contigs, namely, Arc, and subjecting the connection relationship to a second filtration; subjecting continuous contigs without a fork to a second linearization; obtaining output the sequence assembling with contigs; aligning a single-end read and a paired-end read to the contig data, to obtain information between reads and contigs; establishing a connection among the contigs, constructing a graph taking the contigs as dots and the connection as a side; subjecting obtained graph to a pre-treatment and a division, to obtain a plurality of separate subgraphs; outputting a transcript based on the plurality of subgraphs. The present disclosure also provides a system for transcriptome assembly, comprising: a unit for contig assembly, for assembling reads having an overlap; and a unit for bracket assembly, for assembling the contigs into an integrated transcriptome. The present disclosure is accomplished based on the above.

### TERMS

Gene and Exon

As used herein, the term “gene” refers to a basic unit for biological hereditary, presenting in a genetic region of a genome. In an eukaryote organism, the gene consists of an intron and an exon. In general, the gene includes a plurality of the exons. In many cases, the gene has a plurality of transcripts, in which each of the plurality of transcripts is a different combination of the plurality of the exons in the gene, even with a plurality of bases being inward to an exon from a boundary thereof, or being outward to an adjacent intron, which may be known as alternative splicing. Due to these reasons, one gene may have a plurality of transcripts. An organism may obtain different transcripts under different environments and different times.

Pair-End Sequencing

When being subjected genetic fragments (including DNA and cDNA) to sequencing, sequenced subjects are physically contiguous nucleotide sequence fragments, which are called insert fragments, having a length called as insertsize.

As used herein, the term “pair-end sequencing” is to sequence the nucleotide sequence at both sides of the insert fragments from two ends to interior thereof, and obtained sequences after sequencing are called as reads, having a length called as read-length. Since the obtained sequence after sequencing at both sides derive from one same insert fragment, with a distance between the two ends being as insertsize, then the obtained sequence after sequencing at both sides have a determined pair-relationship. Such two reads are called as pair-end reads.

High-Throughput Sequencing

High-throughput sequencing with a genome allows human to find abnormal changes in disease-related genes as early as possible, contributing to the in-depth study with diagnosis and treatment of individual diseases. In general, a person skilled in the art may use three kinds of a Next-Generation sequencing platform for performing high-throughput sequencing: 454FLX (Roche Company), Solexa Genome Analyzer (Illumina Company) and SOLID of Applied Bio systems Company, etc. The common characteristic of these platforms is extremely high sequencing throughput, relative to 96 capillary sequencing of conventional sequencing, the high-throughput sequencing may take readings of 400,000 to 400,000 sequences for each time of experiment, according to different platform, the reads may have different lengths of from 25 bp to 450 bp, by which 1 G to 14 G of different base amount may be obtained for each time of experiment in different sequencing platforms.

Solexa high-throughput sequencing may include two steps of DNA cluster formation and sequencing on computer: subjecting a mixture of PCR amplification product to hybridization with a sequencing probe fixed on a solid-phase carrier, and to a solid-phase bridge PCR amplification, to form a sequencing cluster; subjecting the sequencing cluster to sequencing by means of synthesis by sequencing, to obtain sequencing of nucleic acid molecule in a sample.

The DNA cluster is formed by followings: using a sequencing chip (flow cell) having a layer of a single-strand primer on a surface thereof, a single-strand DNA fragment is fixed on the surface of the chip via connecting an adaptor sequence with the single-strand primer on the surface thereof by means of complementary base-pairing principle, in which fixed single-strand DNA becomes to a double-strand DNA by an amplification reaction, which then becomes to two single-strands again, which anchors onto the surface of the sequencing chip at one end, and is complementary randomly with another primer nearby at the other end to be anchored, forming “a bridge”; ten millions of DNA single molecules occur the above reaction simultaneously on the sequencing chip; formed single-strand bridge is subjected to an amplification again on an amplification chip with a surrounding primer as an amplification primer, to form a double-strand, which becomes a single-strand by denaturation to become a bridged again, being as an amplification template for next cycle of amplification; 30 cycles of amplifications are performed, by which each single molecule is amplified 1000 times, known as a monoclonal DNA cluster.

The DNA cluster is subjected to sequencing using synthesis by sequencing on a Solexa sequencer. In a sequencing reaction, four bases are respectively labeled with different fluorescence, of which ends are blocked by a protective base. Each time of reaction can only add one base, and after being scanned and taken readings of reaction color, the protective group is removed, by which the next reaction can be continued, after being repeated, an accurate sequence consisting of bases is obtained. An index is used to distinguishing samples during Solexa Multiplexed Sequencing, and an extra sequencing was performed with the index part after completing the conventional sequencing. Through identification by the index, up to 12 kinds of different samples can be distinguished within one sequencing channel.

Contig and Contig Assembly

As used herein, the term “contig” means overlapping nucleotide sequences. After being respectively sequenced, genetic fragments containing sequence tags site (STS) are subjected to contig analysis, which may obtain an integrate sequence, in which those being used in the analysis are contigs.

The basic principle of obtaining contigs is to “break” impossible-treated DNA into pieces, which are then connected again. A physical map is obtained by taking Mb, kb and by as a map distance, and STS sequence of the DNA probe as a landmark. One of the main contents of constructing the physical map is to connect DNA cloning fragments containing STS into contig having overlapping fragments. A library containing DNA fragments may include contigs having highly-representative fragments with 100% of construction overall coverage.

As used herein, the term “contig assembly” mainly solves a problem of assembling reads having an overlap obtained from sequencing. In contig assembly, a phenomenon of uneven depth may cause part of sequencing errors having a relative high depth, which cannot be effectively removed only depending on a method of setting a cut-off like a genome assembly, while a phenomenon of alternative splicing may cause a presence of reasonable bubble cases, which are mixed with bubbles resulted from the sequencing error, being not able to be incorporated. Thus, the method for contig assembly used in the present disclosure uses a ratio method: in one transcriptome, even if sequencing error has a certain depth, it is still relative lower comparing to that of the transcriptome, which can be effectively removed according to a preset ratio cut-off.

In a preferred example of the present aspect, kmer filtration may include: deleting an unconfident kmer, deleting kmer having a low depth, deleting removing a tip having a length being less than twice of one kmer's length; or a combination thereof.

In another preferred example, the unconfident kmer is that: in a kmer set having same out-degree or in-degree of one kmer, taking the maximum depth of a kmer as a standard, a kmer having a depth being less than 10% (preferably 5%) of the standard is the unconfident kmer. The low depth is a depth being less than a certain standard, with a default value of 0, which may be determined through a program parameter by a user.

The step of deleting unconfident connection data comprises:

(i) deleting connection data between a continuous sequences of which one sequence has a low weight and the other sequence connected thereof has a high depth;

(ii) deleting connection data among continuous sequences having a low weight, in the case of the continuous sequences having a plurality of out-degrees with a large difference therein;

(iii) deleting connection data among continuous sequences having a low weight, in the case of the continuous sequences having both the out-degree and the in-degree with a large difference therein; or

(iv) a combination thereof.

In another preferred example, the high depth in the (i) is that: the other sequence connected thereof has a depth being 25 times higher than the weight of the connection data between the continuous sequence.

In another preferred example, the low weight in the (i) is that: the one sequence has a weight being less than 3 (preferably, being less than 2).

In another preferred example, in an out-degree set consisting of the plurality of out-degrees among the continuous sequences in the (ii), connection data having a weight being less than 3% of the maximum weight among the continuous sequences is the connection data having the low weight.

In another preferred example, the large differences among the plurality of out-degrees in the (ii) refers that the minimum out-degree is 5% or more smaller than the maximum out-degree, preferably 10% or more smaller than the maximum out-degree.

In another preferred example, in the case of having both the out-degree and the in-degree in the (iii), calculating a weight sum of the connection data among all continuous sequences within the out-degree, and deleting connection data having a weight being less than 2% of the weight sum within the out-degree; calculating a weight sum of the connection data among all continuous sequences within the in-degree, and deleting connection data having a weight being less than 2% of the weight sum within the in-degree.

In a preferred example of the present disclosure, the method of contig assembly may comprise: constructing a kmer graph based on transcriptomic reads obtained by sequencing a sample; subjecting the kmer graph to a first filtration and a first linearization, to form continuous sequences; obtaining a connection relationship (Arc) among the continuous sequences, and subjecting the Arc to a second filtration; subjecting continuous sequences without a fork to a second linearization; repeating steps of Arc filtration and linearization until a sequence presents no changes, to output the sequence assembling with contigs.

Bracket and Bracket Assembly

As used herein, the term “bracket” or “scaffold” may be interchangeable used, being a sequence fragment which is used to assemble into the integrate transcriptome or genome.

The present disclosure provides a method for scaffold assembly, of which the key point is to construct a transcriptome containing a phenomenon of alternative splicing: dividing a scaffold graph into a plurality of separated subgraphs, in which each of which means on transcrisptome. In a preferred example of the present disclosure, the method of dividing the scaffold graph into a plurality of subgraphs includes: classifying contigs having a connection into one category by the scaffold, i.e., subgraph, such as: contig1 connects to contig3, conti3 connects to contig5, while there are on other connections of contig1, contig3 and contig5, and then contig1, contig3 and contig5 and connections thereof constitute one subgraph. Every subgraph is constructed to output an integrate transcript having continuity.

In a preferred example of the present disclosure, the method of scaffold assembly includes: aligning a single-end read and a paired-end read to outputting sequence of contigs, to obtain information between reads and contigs; establishing a connection among the contigs; constructing a graph taking the contigs as dots and the connection as a side; dividing obtained graph into a plurality of separate subgraphs; outputting a transcript based on the plurality of subgraphs.

Method and System for Transcriptome Assembly

The present disclosure also provides a method for transcriptome assembly, comprising contig assembly and scaffold assembly.

In a preferred example of the present disclosure, the method includes: constructing a de Brujin graph based on transcriptomic reads; subjecting the de Brujin graph to a first filtration and a first linearization, to form continuous contigs; obtaining a connection relationship among contigs, and subjecting the connection relationship to a second filtration; subjecting continuous contigs without a fork to a second linearization; repeating steps of filtration and linearization until a sequence presents no changes, to obtain the sequence assembling with contigs; aligning a single-end read and a paired-end read to the contig data, to obtain information between reads and contigs; establishing a connection among the contigs, constructing a graph taking the contigs as dots and the connection as a side; subjecting the graph to a pre-treatment and a division, to obtain a plurality of separate subgraphs; outputting a transcript based on characteristics of the plurality of subgraphs and corresponding arrangement.

The present disclosure also provides a system for transcriptome assembly, comprising a unit for contig assembly, for assembling reads having an overlap; and a unit for bracket assembly, for assembling the contigs into an integrated transcriptome.

The step of subjecting kmer to a linearization includes: if kmer=3, in which 2 kmers may be: ATC and TCA, then a sequence of ATCA is obtained after linearization. In general, other than 2 kmers, a large amount of linear kmers are subjected to linearization, in which obtained sequence is defined as an overlapping (edge). The linear kmer has a single out- or in-degree, such as single out-degree: kmer: ATC, with TCA only, but without TCT, TCC and TCG, then, the ACT only has a single out-degree; and the single in-degree is similar.

Tuple and de Brujin Graph

As used herein, the term “tuple” or “kmer” may be interchangeably used, refers to a DNA sequence fragment having a length of k and a combination thereof, in which k is a positive integer. The kmer has various uses, such as in correcting sequencing errors, constructing contig, and estimating genome size, heterozygosis rate and duplicate sequence content, etc.

As used herein, the term “de Brujin graph”, “kmer graph” or “de Brujin graph” may be interchangeably used.

The first step of transcriptome assembly is to firstly cut a fragment in a walking manner to have a length of kmer, for example, for a fragment having a length of 75 bp, when kmer is 50, generated fragments are 1 to 50 bp, 2 to 51 bp, 3 to 52 bp, etc; and then to subjecting the generated fragments having a length of kmer to matching, if two kmer fragments cannot be matched, it indicates that these two kmer fragments can be connected together.

Any common method may be used to construct a graph for sequence assembly by those skilled in the art, in a preferred example, the method includes: i. receiving sequencing sequence; ii. cutting received sequencing sequence to obtain a short sequence having a fixed length of bases in a manner of sliding base by base, and obtaining a left-and-right connection relationship of the short sequence; iii. saving a sequence value of every short sequence, the left-and-right connection relationship and a connection amount as one node of a de Brujin graph, to realize constructing a graph based on the short sequence.

Overlapping

As used herein, the term “overlapping” and “edge” may be interchangeably used, referring to a relative longer fragment connected by a group of short fragments through overlapping sequences. An overlapping record represents a continuous sequence constructed based on a plurality of cloning sequences. These records may include a draft or a completed sequence, also may include a sequence gap (within a single clone) or a gap among a plurality of clones spanning other unsequenced clones.

N50

The sum of all contig lengths is taken as a comparing subject, such as 500 Mb, containing contigs from 100 bp to 500 bp. The contigs are removed one by one starting from the longest one or the shorted one, while lengths of the removed contigs are added together. When a certain contig is removed, the total length of all added removed (or retained) contigs is half of all contig lengths, the length of the certain contig is a value of N50.

Obtaining Continuous Transcript by Greedy Algorithm

The present disclosure also provides a method of obtaining continuous transcript by greedy algorithm, in a preferred example of the present disclosure, there are connections among contigs in the plurality of subgraphs, such connections have amount information of supporting reads, and then the connection is calculated to obtain a weighted value based on the read information, by which a weighted graph is constructed, with a starting point of a contig without in-degree, and a terminating point of a contig without out-degree, in which the subgraphs have not only one starting point and terminating point.

Finding a Cycle Based on a Graph Theory of Strong Connected Branches

A conventional method may be used to find a cycle based on a graph theory of strong connected branches by a person skilled in the art, for example: the method in http://iprai.hust.edu.cn/icl2002/algorithm/algorithm/commonalg/graph/connectivity/strongly_connected_components.htm. Information of a and b in an example of a strong connected subgraph by strong connected branches; and if a plurality of dots present in a region, then a cycle must exist: such as: a->b->e->a. While in scaffold program application, h with a situation of pointing itself h->h does not exist, namely it may obtain: a graph is divided into a plurality of regions based on a method of strong connected branches, if there is only one dot in each region, then a cycle does not exist in this graph; in contrast: if there are a plurality of dots in each region, then a cycle must exist in this graph. Accordingly, a cycle can be found based on a graph theory of strong connected branches.

Post-Work of Transcriptome Assembly

After performing transcriptome assembly, the assembled transcriptome needs to be subjected to annotation, component analysis, gene prediction, etc.

In a specific example, the step of subjecting scaffold obtained by assembly to gene annotation of whole genome may comprise: prediction of coding gene, annotation of duplicate sequence, Non-coding RNA gene annotation, MicroRNA gene annotation, tRNA gene annotation, pseudogene annotation, etc.

Software which may be used in coding gene includes: genomic component analysis Augustus: http://augustus.gobics.de/; Fgenesh: http://www.softberry.com/; Genemark: http://exon.biology.gatech.edu/.

Software which may be used in annotation with predicted gene function (Gene Ontology, regulation of Motif, Pathway, etc): InterproScan, SignalP, SMURF, etc.

Method of Evaluating a Transcript

The present disclosure further provides a method for evaluating a transcript.

Accuracy: aligning a result to a Gene reference sequence, in which an aligning length being larger than 95% of that of the result itself is regarded as being accurate.

Continuity: aligning a result to an mRNA reference sequence, in which 80% of the mRNA length to which the same result can be aligned, is regarded as having an excellent continuity.

Major Advantages of the Present Disclosure Lies in:

1. the method for transcriptome assembly and the system thereof may effectively construct a transcriptome, which guarantee integrity and continuity of obtained result;

2. may guarantee an assembling result with a high quality, which may effectively process sequencing error;

3. may effectively use information of all reads, which may use a plurality of libraries and insert fragments having a large length;

4. may be unnecessary to set a depth cut-off, which may shield a large scale of data;

5. may construct a transcriptome with a phenomenon of alternative splicing by a simple and reasonable solution;

6. the method and system thereof greatly decrease memory and time consumed by constructing DBG graph.

Reference will be made in detail to examples of the present disclosure. It would be appreciated by those skilled in the art that the following examples are explanatory, and cannot be construed to limit the scope of the present disclosure. If the specific technology or conditions are not specified in the examples, a step will be performed in accordance with the techniques or conditions described in the literature in the art, for example, referring to J. Sambrook, et al., Molecular Cloning: A Laboratory Manual (New York: Cold Spring Harbor Laboratory Press) or in accordance with the product instructions.

### Example 1

### Contig Assembly

The contig assembly in the present example mainly solved sequencing error and subjected read information to contig assembly, which includes following steps:

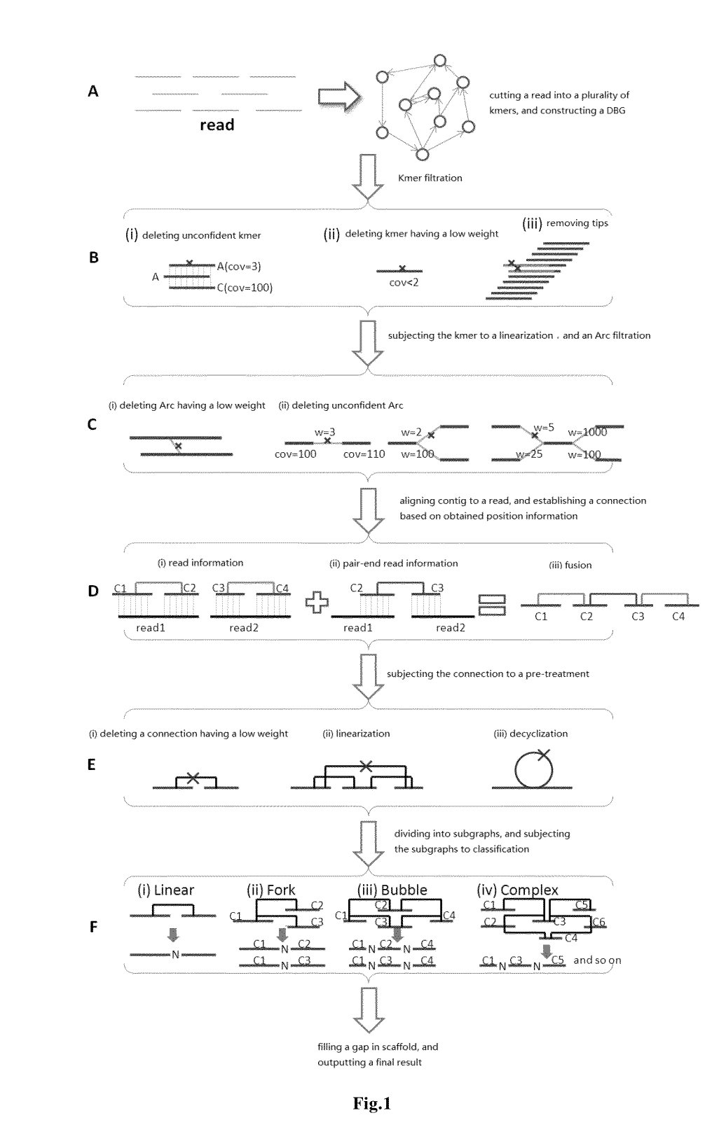

1. Contig assembly was performed by cutting a fragment into reads to a Hash set, so as to construct a kmer graph, shown as FIG. 1A;

2. deleting an unconfident kmer, shown as FIG. 1B(i);

3. deleting a kmer having a low depth, shown as FIG. 1B(ii);

4. removing a tip having a length less than 2 kmer without an out-degree, shown as FIG. 1B(iii);

5. subjecting a kmer without a fork to linearization, to form a continuous sequence, named edge;

6. obtaining a connection relationship among the edge, named Arc, in which Are is that: based on a sequence having a length of k+1 in a read, the connection relationship equals to frequencies of reads supporting a region having the length of k+1;

7. deleting Arc having a low depth, shown as FIG. 1C(i);

8. deleting unconfident Arc, shown as FIG. 1C(ii):

(a) if Arc had a low weight and a continuous sequence connected to the Arc had a high depth, then it could be an error connection most likely resulted from sequencing error;

(b) if a continuous sequence has a plurality of out-degrees, in which one is very high, another one is relative low, then the continuous sequence could be regarded as an error connection;

(c) if a continuous sequence has both in- and out-degrees, and there is not very large difference between the in- and out-degrees, then those having a relative smaller weight should be deleted;

9. subjecting continuous contigs without a fork to a second linearization;

10. repeating steps 7 to 9 until a sequence presents no changes, to obtain the sequence assembling with contigs.

Due to uneven depths, some transcripts had a high expression, resulting in a relative high expression of sequencing error in these transcripts, by which the sequencing error could not be removed by setting a depth cut-off. The method of the present example could identify sequencing error using a depth ratio, by which an accurate contig sequence could be assembled, of which a part thereof could be output as a transcript.

### Example 2

### Scaffold Assembly

In the present example, inventors constructed a graph using information of a single-end read and a pair-end read, to obtain a transcript, which included following steps:

1. aligning reads to contig, to obtain information between the reads and the contigs, including: an initial position, an aligning length, a direction;

2. establishing a connection among the contigs based on read information, shown as FIG. 1D, the connection information included: a read supporting number, a gap between contigs;

3. deleting a connection having a low weight, shown as FIG. 1E(i);

4. subjecting some information redundancy to a linearization, for example, if A->B, B->C, A->C, in which a gap between A and C is sufficient to accommodate B, then a connection from A to C could be deleted, shown as FIG. 1E(ii);

5. decyclization mainly processed a cycle caused by duplicate sequence, sequencing error, a method of decyclization included finding a cycle based on a graph theory of strong connected branches, and then subjecting to process, shown as FIG. 1E(iii);

6. after being pretreated, the graph was divided into a series of separate subgraphs, which were classified into 4 kinds of cases: a line graph, a branch graph, a bubble graph, a complex graph, or a combination thereof:

(a) the former cases could easily obtain a corresponding transcript, shown as FIG. 1F(i) to FIG. 1F(iii);

(b) in a case of the complex graph, a situation of some special alternative splicing was more complex than the former 3 cases, which could generate some error connections caused by sequencing error that was not completely processed previously, then the plurality of subgraphs should be connected together, to generate a complex graph, which has a larger possibility, then a few of best transcripts were obtained in a weight graph by greedy algorithm.

### Example 3

### Verification with Transcriptome Assembly of Mice

Real data (with a data volume of 7.4 G) of mice was used for verification in the present example. A reference sequence for aligning a transcriptome assembly result was a known transcriptomic sequence to which a sequencing sequence was aligned; those sequencing sequences which could cover into the known transcriptomic sequence were extracted, being as the reference sequence.

Information of relative reference sequence was shown in Table.1.

TABLE 1

| The sum of all bases | | The number | |
|---|---|---|---|
| in the | | of reference sequence | |
| reference | The number of the | having a base number | |
| sequence (bp) | reference sequences | being more than 1000 | N50 |
| 17806361 | 5656 | 5151 | 3888 |

A result obtained by the method of transcriptome assembly of mice according the method of the present disclosure was shown in Table.2.

TABLE 2

| | | The number of | |
|---|---|---|---|
| | | assembling | |
| The sum of all bases in | The number of | result being more than | |
| assembling result (bp) | assembling result | 1000 | N50 |
| 56840716 | 84336 | 13945 | 2730 |

The assembling result was aligned to the reference sequence. The accuracy, integrate and continuous result by the method of the present disclosure was shown in Table.3.

TABLE 3

| accuracy | integrity | continuity |
|---|---|---|
| 88.60% | 98.20% | 90.49% |

A formula for calculating accuracy:

$$Accuracy = 100 \times \frac{{\sum }_{i = 1}^{M} {A}_{i}}{{\sum }_{i = 1}^{M} {L}_{i}}$$

A formula for calculating integrity (completeness):

$$Completeness = 100 \times \frac{{\sum }_{i = 1}^{N} / ( {C}_{i} \geq δ )}{N}$$

A formula for calculating continuity:

$$Contiguity = 100 \times \frac{{\sum }_{i = 1}^{N} / ( {C}_{i} \geq δ )}{N}$$

The result showed that: the completeness of assembly by the method of the present disclosure could be up to 90% or more, which could assemble most of mRNA sequence, with a high accuracy, being up to 88% or more, which resulted in a result with a strong continuity.

### Example 4

### Verification with Transcriptome Assembly of Rice

Real data (with a data volume of 2.1 G) of rice was used for verification in the present example. Information of relative reference sequence was shown in Table.4.

TABLE 4

| The sum of all | | The number of reference | |
|---|---|---|---|
| bases in the | | sequence having a base | |
| reference | The number of the | number being | |
| sequence (bp) | reference sequences | more than 1000 | N50 |
| 959049 | 668 | 395 | 1949 |

A result obtained by the method of transcriptome assembly of rice according the method of the present disclosure was shown in Table.5.

TABLE 5

| | | The number of | |
|---|---|---|---|
| | | assembling | |
| The sum of all bases in | The number of | result being more than | |
| assembling result (bp) | assembling result | 1000 | N50 |
| 31098204 | 66191 | 8968 | 1018 |

The assembling result was aligned to the reference sequence. The accuracy, integrate and continuous result by the method of the present disclosure was shown in Table.6.

TABLE 6

| accuracy | integrity | continuity |
|---|---|---|
| 88.4% | 90.27% | 70.66% |

The result showed that: the completeness of assembly by the method of the present disclosure could be up to 90% or more, which could assemble most of mRNA sequence, with a high accuracy, being up to 88% or more, which resulted in a result with a strong continuity.

All the documents cited herein are incorporated into the invention as reference, as if each of them is individually incorporated. Further, it would be appreciated that, in light of the above described teaching of the invention, those killed in the art could make various changes or modifications to the invention, and these equivalents would still be within the scope of the invention defined by the issued claims of the application.

What is claimed is:

1. A method for contig assembly, comprising following steps:
(1) constructing a de Brujin graph based on transcriptomic reads obtained from a sample;
(2) subjecting the de Brujin graph obtained in the step (1) to a first filtration and a first linearization, to form continuous contigs;
(3) obtaining a connection relationship among the contigs, and subjecting the connection relationship to a second filtration;
(4) subjecting continuous contigs without a fork to a second linearization;
(5) repeating step the (3) and the step (4) until a sequence presents no changes, to obtain the sequence assembling with contigs.

2. The method of claim 1, wherein the first filtration in the step (2) is selected from followings:
(a) deleting an unconfident tuple;
(b) deleting a tuple having a low depth;
(c) removing a tip having a length being less than twice of one tuple's length; or
(d) a combinations thereof,
preferably, the unconfident tuple is that: in a tuple set having same out-degree or in-degree of one tuple, taking the maximum depth as a standard, a tuple having a depth being less than 10% (preferably 5%) of the standard is the unconfident tuple,
preferably, the low depth is a depth being no more than 3, preferably a depth being no more than 2, more preferably a depth being 0, with the depth being 0 indicating that a user does not use such function.

3. The method of claim 1, wherein the connection relationship between contigs in the step (3) is that: based on a sequence having a length of k+1 in a read, the connection relationship equals to frequencies of reads supporting a region having the length of k+1.

4. The method of claim 1, wherein the second filtration in the step (3) is selected from following:
(a1) deleting connection data having a low depth;
(b1) deleting unconfident connection data; or
(c1) a combinations thereof.

5. The method of claim 4, wherein deleting unconfident connection data comprises:
(i) deleting connection data between a continuous sequences of which one sequence has a low weight and the other sequence connected thereof has a high depth;
(ii) deleting connection data among continuous sequences having a low weight, in the case of the continuous sequences having a plurality of out-degrees with a large difference therein;
(iii) deleting connection data among continuous sequences having a low weight, in the case of the continuous sequences having both the out-degree and the in-degree with a large difference therein; or
(iv) a combination thereof;
preferably, wherein the high depth in the (i) is that: the other sequence connected thereof has a depth being 25 times higher than the weight of the connection data between the continuous sequence, preferably, being 30 times higher than the weight of the connection data between the continuous sequence;
preferably, wherein the low weight in the (i) is that: the one sequence has a weight being less than 3 (preferably, being less than 2);
preferably, wherein in an out-degree set consisting of the plurality of out-degrees among the continuous sequences in the (ii), connection data having a weight being less than 3% of the maximum weight among the continuous sequences is the connection data having the low weight;
preferably, wherein the large differences among the plurality of out-degrees in the (ii) refers that the minimum out-degree is 5% or more smaller than the maximum out-degree, preferably 10% or more smaller than the maximum out-degree;
preferably, wherein in the case of having both the out-degree and the in-degree in the (iii), calculating a weight sum of the connection data among all continuous sequences within the out-degree, and deleting connection data having a weight being less than 2% of the weight sum within the out-degree; calculating a weight sum of the connection data among all continuous sequences within the in-degree, and deleting connection data having a weight being less than 2% of the weight sum within the in-degree.

6. A method for brackets assembly, comprising following steps:
(a) obtaining contig data for assembling, aligning a single-end read and a paired-end read to the contig data, to obtain information between reads and contigs;
(b) establishing a connection among the contigs, constructing a graph taking the contigs as dots and the connection as a side;
(c) subjecting the graph obtained in the step (b) to a pre-treatment and a division, to obtain a plurality of separate subgraphs;
(d) outputting a transcript based on the plurality of subgraphs obtained in the step (c);
preferably, the information between reads and contigs in the step (a) is selected from following groups: an initial position, an aligning length, a direction, or a combination thereof;
preferably, the connection among the contigs in the step (b) is selected from following groups: a read supporting number, a gap between contigs, or a combination thereof.

7. The method of claim 6, wherein the pre-treatment in the step (c) is selected from following groups:
(A) deleting a connection among contigs having a weight being less than 3;
(B) subjecting to a linearization, to deal with redundant information;
(C) subjecting to a decyclization; or
(D) a combination thereof,
preferably, wherein subjecting to the decyclization refers to deleting duplicate sequence, and/or cycling information caused by error sequencing;
preferably, wherein the decyclization comprises: finding a cycle based on a graph theory of strong connected branches; and deleting a connection having a minimum weight within the cycle.

8. The method of claim 6, wherein the sub-graph in the step (d) comprises: a line graph, a branch graph, a bubble graph, a complex graph, or a combination thereof.

9. A method for transcriptome assembly, comprising following steps:
(A) performing contig assembly using the method of claim 1, to obtain contig data; and
(B) subjecting the contig data to a bracket assembly using the method of claim 6, to obtain transcript data.

10. A unit for contig assembly, comprising:
(A1) a tuple constructing module, for constructing a de Brujin graph with sequenced transcriptomic reads;
(B1) a tuple filtering module, for subjecting a tuple to a first filtration;
(C1) a tuple linearizing module, for subjecting a tuple without a fork to a first linearization, to obtain continuous contigs;
(D1) a connection processing module, for obtaining a connection relationship among the contigs, and subjecting the connection relationship to a second filtration and a second linearization;
(E1) an outputting module, for outputting a sequence assembling with contigs.

11. A unit for bracket assembly, comprising:
(A2) an aligning module, for aligning a single-end read and a paired-end read to contigs, to obtain information between reads and the contigs;
(B2) a graph constructing module, for constructing a graph, and/or subjecting the graph to a pre-treatment;
(C2) a subgraph processing module, for dividing the graph into a plurality of separate subgraphs;
(D2) a subgraph assembling module, for subjecting transcripts obtained from the plurality of separate subgraphs to assembly, to obtain transcript assembling information.

12. A system for transcriptome assembly, comprising:
(A) the unit for contig assembly of claim 10, for assembling reads having an overlap; and
(B) the unit for bracket assembly of claim 11, for assembling the contigs into an integrated transcriptome.
